(19) United States
(12) Patent Application Publication
(10) Pub. No.: US 2014/0278770 A1
(43) Pub. Date: Sep. 18, 2014

(54) GENERATING ECONOMIC MODEL BASED ON BUSINESS TRANSACTION MESSAGES

(71) Applicant: International Business Machines Corporation, Armonk, NY (US)

(72) Inventors: Jason Eric Hardy, Powell, OH (US); Steven W. Keller, Columbus, OH (US); Seema Nagar, Bangalore (IN); Amit Anil Nanavati, New Delhi (IN); Ramasuri Narayanam, Andhra Pradesh (IN); Yehuda Naveh, Haifa (IL); Amir Ronen, Haifa (IL)

(73) Assignee: International Business Machines Corporation, Armonk, NY (US)

(21) Appl. No.: 13/798,214

(22) Filed: Mar. 13, 2013

(51) Int. Cl. G06Q 30/02

(52) U.S. Cl. CPC G06Q 30/0202
USPC 705/7.31

(57) ABSTRACT

A computer-implemented method, computerized apparatus and computer program product for generating economic model based on business transaction messages. The method comprising obtaining business transactions from a business collaboration network, wherein each business transaction is a business-to-business transaction; and automatically generating, by a processor, based on the business transactions, an economic simulator capable of simulating economic activity within the business collaboration network, wherein the economic activity is associated with a business transaction that is transmitted via the business collaboration network.

### TECHNICAL FIELD

The present disclosure relates to computer-aided business processes in general, and to computerized networks of business transactions, in particular.

### BACKGROUND

Today, many business processes are performed, at least partially, using computerized devices. In case the business process is performed by two separate businesses. Business-to-business (B2B) communications, also referred to as business transactions, are exchanged via a business collaboration network. Business transactions include, for example, invoices, purchase orders, debit notes, shipping notes, or the like.

Business collaboration networks facilitate the exchange of business transactions between the business entities. In some cases, business collaboration networks provide for Electronic Data Interchange (EDI) between business entities. The business collaboration network may be a designated network for the business collaboration purposes. Alternatively, the business collaboration network may be implemented over a general network, such as the Internet. As an example, the business collaboration network may be implemented by transmitting encrypted XML based messages over the Internet. The business collaboration network may facilitate transmission of encrypted messages, in a secure and reliable manner and can be therefore entrusted with confidential information.

The business collaboration network may help automate many B2B communications thereby reducing the dependency on paper transfers and cutting costs. The B2B communications may also speed up a wide range of tasks and processes, such as for example inventory, order management, payment and the like.

As is known in the art, the business collaboration network may be Value-added Network (VAN).

### BRIEF SUMMARY

One exemplary embodiment of the disclosed subject matter is a computer-implemented method comprising: obtaining business transactions from a business collaboration network, wherein each business transaction is a business-to-business transaction; and automatically generating, by a processor, based on the business transactions, an economic simulator capable of simulating economic activity within the business collaboration network, wherein the economic activity is associated with a business transaction that is transmitted via the business collaboration network.

Another exemplary embodiment of the disclosed subject matter is a computerized apparatus having a processor coupled with a memory unit, the processor being adapted to perform the steps of: obtaining business transactions from a business collaboration network, wherein each business transaction is a business-to-business transaction; and automatically generating, by a processor, based on the business transactions, an economic simulator capable of simulating economic activity within the business collaboration network, wherein the economic activity is associated with a business transaction that is transmitted via the business collaboration network.

Yet another exemplary embodiment of the disclosed subject matter is a computer program product comprising a non-transitory computer readable medium retaining program instructions, which instructions when read by a processor, cause the processor to perform the steps of: obtaining business transactions from a business collaboration network, wherein each business transaction is a business-to-business transaction; and automatically generating, by a processor, based on the business transactions, an economic simulator capable of simulating economic activity within the business collaboration network, wherein the economic activity is associated with a business transaction that is transmitted via the business collaboration network.

### BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows an illustration of a computerized environment in accordance with some exemplary embodiments of the disclosed subject matter;

FIG. 2 shows a block diagram of a system, in accordance with some exemplary embodiments of the disclosed subject matter;

FIG. 3 shows an illustration of a network graph of a BCN, in accordance with some exemplary embodiments of the disclosed subject matter;

FIG. 4 shows an illustration of a node, in accordance with some exemplary embodiments of the disclosed subject matter;

FIG. 5 shows a flowchart diagram of steps in a method, in accordance with some exemplary embodiments of the disclosed subject matter; and

FIG. 6 shows a block diagram of an apparatus, in accordance with some exemplary embodiments of the disclosed subject matter.

### DETAILED DESCRIPTION

The disclosed subject matter is described below with reference to flowchart illustrations and/or block diagrams of methods, apparatus (systems) and computer program products according to embodiments of the subject matter. It will be understood that blocks of the flowchart illustrations and/or block diagrams, and combinations of blocks in the flowchart illustrations and/or block diagrams, can be implemented by computer program instructions. These computer program instructions may be provided to one or more processors of a general purpose computer, special purpose computer, a tested processor, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transient computer-readable medium that can direct a computer or other programmable data processing apparatus to function in a particular manner, such that the instructions stored in the non-transient computer-readable medium produce an article of manufacture including instruction means which implement the function/act specified in the flowchart and/or block diagram block or blocks.

The computer program instructions may also be loaded onto a device. A computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

One technical problem dealt with the disclosed subject matter is providing for a reliable model of an economic environment including a plurality of businesses which depend on one another. The economic environment may be composed of separate economic entities that each may be associated with a different behavior, and together they form an eco-system in which B2B interactions occur. A first entity may manufacture product that can be used as a factor of production by a second entity. The second entity may purchase in a business transaction the output of the first entity in order to produce its product, which in turn may be bought by a third entity. The eco-system may further be characterized in having a plurality of competitors, each having different production capabilities (e.g., due to differences in technology, quality of human resource, or the like), each having a different pricing scheme, and potentially using different inputs for production. Predicting outcomes of events in such a system is non-trivial and may be hard to do.

Another problem dealt with by the disclosed subject matter is to harness information available in business collaboration network. The Business Collaboration Network, also referred to as BCN, may be operated by a single owner. While the data of each business transaction is confidential and should not be used or disclosed, the aggregated data may be used

One technical solution is to obtain business transactions of the BCN and use them to generate an economic simulator capable of simulating the eco-system monitored. The simulator may be used as an economic model and in particular be used to predict repercussions of economic events in the monitored eco-system.

The input used by the disclosed subject matter may be a stream of business transactions, such as purchase orders, invoices and the like. Each business transaction may indicate an origin and a destination indicating two business entities involved in the business transaction. The business transaction may be further indicate a type of communication, such as for example whether this is a purchase order or an invoice. In addition for each business entity, additional characteristics may be obtained or provided, such as industry, geographic location, company size, or the like. Such information may be extracted from the Internet, may be obtained from a user, may be obtained from a database, or from any other source. In some exemplary embodiments, such information is obtained from a source external to the business transaction.

The disclosed subject matter may identify influence relations between companies based on the business transactions in the BCN. Based on the relations, a network of economic interactions may be defined. The network may be a graph in which a node is associated with a business entity and an edge represents relation between business entities. In some cases, only some of the relations, e.g., above a predetermined minimal significance threshold, are introduced to the graph. In some cases, the edge may be weighted to quantify the relation. In some exemplary embodiments, some business transactions may be ignored, such as business transaction of a certain types, business transactions occurring between business entities at a frequency below a threshold, or the like.

In some cases, the nodes may be associated with a group of businesses, such as an industry, businesses in the same geographic area, business in the same area of the same industry, or share some other common characteristic.

In some exemplary embodiments, based on the business transactions in the BCN which are associated with a node (i.e. a business entity or a group of such entities), a predictive model may be determined. The predicative model may be determined using machine learning techniques, such as supervised learning. The learning may utilize the transactions as a training dataset. The training dataset may be the stream of incoming transactions (e.g., purchasing factors of production) and its corresponding stream of outgoing transactions (e.g., selling products).

In some exemplary embodiments, after the graph is constructed and predictive model determined, the disclosed subject matter may provide for a simulation of a network of well defined economic entities. Economic events, such as demand or prices changes, may be diffused into the network in order to analyze and predict their effect on the whole eco-system. The simulator may be used to predict the future behavior of the eco-system. Additionally or alternatively, the simulator may be initiated with starting conditions to provide for prediction of the eco-system behavior under given constraints.

In some exemplary embodiments, a user may provide a query that may be translated into starting conditions and an economic event. The simulator may be initiated with the starting conditions and the behavior may be simulated. The simulation may be limited to a number of cycles, such as a single cycle, ten cycles, or the like.

In some exemplary embodiments, a cycle in the model may correspond to a timeframe, such as a month. The cycle may be used to aggregate business transactions together and use them for the learning procedure. As an example, transactions A, B and C between entities of node X and Y occurred in the same timeframe and may be treated as a single aggregated transaction occurring in the same cycle. Referring still to this example, and assuming A, B, C and transactions in which entity Y purchased a product from X, than the aggregated amount of the product purchased may be considered as the input of Y at the cycle and the output of X in the cycle. In some exemplary embodiments, the input of Y may also include purchases of the same product from a different entity. Similarly, output of X may include product sold to different entity as well. In some exemplary embodiments, an entity may use more than one type of input or may produce more than one type of product, and in such a case, the input in a cycle may include a vector of aggregated values for each input type received in the cycle, while the output in the cycle may include a vector of aggregated values for each product type produced and sold in the cycle. For simplicity, the disclosed subject matter is explained with respect to business entities in which only a single input type is used and a single output product is provided. However, the disclosed subject matter is not limited to such an example.

One effect is to be able to utilize aggregated information of the BCN to provide a relatively reliable, fact-based, model of the eco-system. As some transactions may not be reflected in the BCN, such as because one participating entity does not use the BCN, the accuracy and quality of the model may depend upon the transactions that are monitored. The quality of the model may increase as the percent of the transactions that are monitored in the BCN increases. Additionally or alternatively, the quality may also increase as the sample of transactions that are monitored is more similar to a representative statistical model of all the transactions by the entity.

Another effect is to allow the operator of the BCN to take advantage of the information passing through its network. In some exemplary embodiments, the information of each transaction may be confidential and privacy preserving algorithms may be used to provide answers to queries without revealing content of a confidential transaction.

Yet another effect is to facilitate verification of a proposed economic model based on a comparison with a model based on empirical results.

Referring now to FIG. 1 showing an illustration of a computerized environment in accordance with some exemplary embodiments of the disclosed subject matter. A Network 100 enables B2B communication. Network 100 may be a BCN, a VAN, or the like. In some exemplary embodiments, Network 100 provides for reliable communication between business entities. Additionally or alternatively, Network 100 may provide encryption of the B2B messages. In some exemplary embodiments, Network 100 is a dedicated computer network. Additionally or alternatively, Network 100 may be implemented over a general computer network such as the Internet.

Network 100 may be provided by a Network Operator 110. Network Operator 110 may be responsible to facilitate the B2B communication via Network 100. Network Operator 110 may monitor all communications via Network 100.

Business entities 120, 125, 130 are exemplary business entities that utilize Network 100 to communicate with one another. The disclosed subject matter may be applicable to networks of any number of business entities. In some exemplary embodiments, each business entity is associated with some characteristics, such as but not limited to an industry in which it operates, a geographic area in which it is located, or the like.

A business transaction (not shown) may be transmitted, for example, from Business Entity 120 to Business Entity 130. The transaction may be, for example, a purchase order, a payment request, an invoice, a receipt, or the like. In some exemplary embodiments, an encrypted version of the transaction may be transmitted via Network 100 to Business Entity 130 and may be monitored by Network Operator 110.

Network Operator 110 may utilize the aggregated information that is observed from the business transactions, such as to determine which business entities are in a direct business relation and of what degree. The aggregated information may be used to determine a predictive model on production of a business entity based on given amounts of factors of production.

Based on the information observed by the Network Operator 110, an economic simulator may be generated. User 140 may utilize the simulator to provide predictions to effects of an economic activity by a business entity on other business entities. The simulator may also make predictions regarding effects of an economic event, such as a macro-economic event, price change, demand change, or the like.

Referring now to FIG. 2 showing a block diagram of a system, in accordance with some exemplary embodiments of the disclosed subject matter.

System 200 may comprise a BCN Monitor 210 configured to monitor messages in the BCN.

Business Transactions Parser 220 may analyze the transaction to determine information such as, for example, transaction type (e.g., invoices, purchase order, etc.), source entity and target entity of the transaction (e.g., who sent the transaction and who is the recipient), quota, total monetary amount of the transaction, time of the transaction, product exchanged in the transaction, or the like. Business Transactions Parser 220 may filter in only specific types of transactions, transaction above a predetermined monetary value, transactions relating to specific products, or the like. The stream of parsed transactions may be provided to a Network Builder 230 as well as to a Node Modeler 240.

Network Builder 230 may construct a network graph in which nodes represent a business entity or a group of related business entities and edges represent economic interactions, economic influence or other economic relations between business entities of the two connected nodes.

Network Builder 230 may construct a network graph in which nodes represent companies and edges represent economic interactions or other important economic relations (e.g. influence relations). In some exemplary embodiments, the graph may be constructed so as to represent group of companies together as a single node, such as an industry, geographic location, industry at a geographic location, or the like.

In some exemplary embodiments, the edges may be weighted edges and the weight may quantify the relation between the nodes. In some exemplary embodiments, the graph is a directed graph. In some exemplary embodiments, the edges may represent only certain relations, such as specific types of relations, relations that supply a trading significant monetary volume between pair of nodes, or the like. In some exemplary embodiments, some edges may be removed if their weight is below a predetermined threshold, such as below a minimal strength measurement.

In some exemplary embodiments, each edge of the graph may be associated with a different product. In case a node purchases more than a single product (e.g., to be used in its production process), it may have multiple incoming edges even from the same node, each associated with a different product.

Node Modeler 240 may be configured to build a model of an individual node or a set of nodes. Node Modeler 240 may receive a series of values incoming to the node and corresponding output values produced by the node at the same cycle or timeframe. As an example, assuming a cycle is measured as a month, Node Modeler 240 of a node purchasing two products and producing a single product may be ([(10, 2), 1], [(12, 4), 2], [(5, 2), 3]) indicating that a first month, the node received 10 items of the first production factor and 2 items of the second production factor and produced one product, at a second month the node received 12 items of the first production factor and 4 of the second and was able to produce two products and on the third month the node received 5 items of the first factor and 2 of the second factor and was able to produce 3 products. The number of cycles provided to the

Node Modeler 240 may be any predetermined number, such as 12 cycles, 100 cycles, or the like, may depend on an amount of monitored data available, and on other factors. In some exemplary embodiments, the values may indicate a number of items, a value of the items, or the like.

Node Modeler 240 may implement machine learning techniques such as, for example, support vector regression, linear or polynomial regression, Gaussian processes, or the like. Node Modeler 240 may build a statistical model capable of providing a prediction of output values based on input values provided to the node, thereby providing a prediction on the production produces by the node given certain input values.

In some exemplary embodiments, Node Modeler 240 may utilize characteristics of the business entity associated with the node to improve its prediction, such as for example selecting a different statistical model that is suitable to the characteristics of the business entity. In some exemplary embodiments, small business entities may be modeled using a first model while big business entities may be modeled using a second model. The terms “small” and “big” may have different meanings in different industries and are used to distinguish from one another. In some exemplary embodiments, industries may include several group sizes, such as for example: micro, small, medium, and corporate.

In some exemplary embodiments, one method for statistical node model building may be as follows: consider a company that buys and purchases everything through the BCN. The company produces a vector of products y=(y₁, . . . , yₙ). In order to produce it needs to consume vectors of raw materials denoted x=(x₁, . . . , xₘ). For example, a company needs to consume wheat in order to produce bread. A possible valid assumption useful for modeling the node is that the ratio between the production and the consumption vectors is roughly linear, i.e. there exists a production matrix M such that approximately y=Mx. Seeing the time series y(t), x(t), such as obtained from the BCN, an estimation of the underlying matrix M may be possible. In some exemplary embodiments, only the principle components of matrix M may be estimated.

An example of a dynamic model that can be learnt is of the form: y(t)˜(I−Γ)y(t−1)+Γ·M·x(t)+Cη, where Γ is a rate matrix, C a covariance matrix and η a Gaussian noise (Γ, M, C are to be estimated). Such a model may give rise to parameter estimation problems which may be solved in feasible time. Once such an estimation is issued it may be used to predict the output y given an alleged vector x or vice versa. Other alternative models may be used for the prediction.

In some exemplary embodiments, Node Modeler 240 may be applied on each node of the network graph built by Network Builder 230. In some exemplary embodiments, different nodes may be modeled using different statistical models or modeling means.

An Economic Simulator 250 may utilize the graph built by Network Builder 230 and the predictive models provided by Node Modeler 240 to simulate an economic activity and diffuse its effect and repercussions to different business entities. Economic Simulator 250 may be used to initialize starting values of inputs and outputs of the nodes, thereby achieving a simulation of a change in a demand (e.g. reduced and increased demand by some economic entities), change in pricing (e.g., reduction in prices of factors of production), or the like. Other economic events may also be simulated.

In some exemplary embodiments, Economic Simulator 250 may be used to simulate on a cycle-by-cycle manner outputs of nodes based on input provided thereto in the former cycle. The outputs may be determined based on the model of the pertinent node. In such a manner, the economic activity may be diffused into the network graph and its effects may be observed.

Graphical User Interface (GUI) 260 may be configured to provide a GUI to a user of System 200 (not shown). The user may utilize GUI 260 to observe the network, predictions, or the like. In some exemplary embodiments, the user may user GUI 260 to provide a query that may be translated into a simulation scenario for Economic Simulator 250. The simulation scenario may include, for example, one or more economic activities to be diffused into the network at one or more cycles, a number of cycles to be simulated, grouping of nodes into a single grouped node that can be simulated as an aggregation of the simulated activity of the nodes comprised by the grouped node, or the like.

In some exemplary embodiments, Visualization Engine 264 may be configured to provide for a visualization of the network and/or outcomes of the simulation. The visualization may be presented to the user via GUI 260.

Query Editor 268 may be configured to allow the user to edit a query to be provided to Economic Simulator 250. The user may edit the query to define the simulation scenario. In some exemplary embodiments, the user may characterize nodes to be grouped together thereby allowing the user to inquire into abstractions of the graph, such as to inquiry as to effects of an economic event on an industry, a localized industry, or the like.

Referring now to FIG. 3 showing an illustration of a network graph of a BCN, in accordance with some exemplary embodiments of the disclosed subject matter.

Graph 300 indicates relations between business entities as is monitored in the BCN. As an example, Node 310 may be associated with a business entity or several business entities that share a common characterization. Edge 335 may indicate that Node 310 receives inputs to its business process products of the business entity of Node 330. In some exemplary embodiments, a weight (not shown) of Edge 335 may indicate strength measurement of the relation between the two nodes, such as fir example indicating a portion of the business cycle of Node 310 and/or Node 330 that is represented by Edge 335. Additionally or alternatively, the weight may indicate dependency of Node 310 on the inputs provided by Node 330.

Similarly, the relation between Node 310 and Node 320 to whom Node 310 provides its product is indicated using Edge 325.

In some exemplary embodiments, edges in Graph 300 indicate a substantial economic activity between the two nodes, such as above a certain percentage (e.g., 1%) of the business cycle of at least one node, above a certain minimal threshold of dollar-value, a combination thereof, or the like.

In some exemplary embodiments, nodes may be connected using more than one edge. Referring now to Node 340 which receives its input from Nodes 350, 360, it can be appreciated that two edges, Edge 342 and Edge 344 connect Nodes 350 and 340. Each edge may be associated with a different product thereby indicating that Node 340 purchases two different products from Node 350. In some exemplary embodiments, edges may be categorized as associated to different products using a coloring scheme or other visual indication, so as to allow a user to understand which of the products are provided by which node. In some exemplary embodiments, a node may require more than a single type of a factor of production to produce a produce. For example, in order to produce cake, it might be required to purchase both wheat and sugar. In some cases, a single node may provide more than a single factor of production, as is exemplified by Node 350.

Referring now to FIG. 4 showing an illustration of a node, in accordance with some exemplary embodiments of the disclosed subject matter. Node 400 may be a node of a graph, such as Graph 300. Buy-Side 410 of Node 400 may include all distinct factors of production provided to Node 400 via the BCN. Each different factor may be visualized using a different arrow (e.g. Arrows 412, 414). All inputs to Node 400 of a single type, no matter from which source they arrive, may be illustrated using the same arrow. Similarly, Sell-Side 420 may indicate all products sold by Node 400, each type of product using a different arrow, such as Arrow 422.

Based on the values of Buy-Side 410 and Sell-Side 420 in a single cycle (e.g., within a predetermined timeframe) a statistical model may be trained to provide for prediction of the Nodes 400 production function. As an example, assuming that Node 400 purchases materials denoted as x=(x₁, . . . , xₙ), where xᵢ refers to a different arrow and indicates aggregated value of the material of the specific type of material purchased from any source. Node 400 produces products denoted as y=(y₁, . . . , yₙ), where yᵢ refers to a different arrow and indicates aggregated value of the product of the specific type of product sold to any destination.

As an example, if Node 310 purchases from Node 330 and Node 360 the same material, the aggregated value (e.g., measured in dollar value, quantity, or the like) of the material purchased in a cycle may be associated with Arrow 412.

It will be noted that FIG. 4 is an illustration of the node modeling process and may or may not be visualized to the user of a system in accordance with the disclosed subject matter.

Referring now to FIG. 5 showing a flowchart diagram of steps in a method, in accordance with some exemplary embodiments of the disclosed subject matter.

In Step 500, business transactions from a BCN may be obtained, such as by BCN Monitor 210.

In Steps 505-525, an economic simulator, such as 250, may be created. In some exemplary embodiments, Steps 510-520 may be performed by a network builder, such as 230. In some exemplary embodiments, Step 525 may be performed by a node modeler, such as 240.

In Step 505, business transactions may be filtered. In some exemplary embodiments, irrelevant business transactions may be dropped and not used the process of creating the economic simulator. The filtering may be performed by a parser, such as 220.

In Step 510, distinct businesses may be grouped together to a single node. The grouping may be performed based on user preference, selection, or command.

In Step 515, transactions between the same source and destination nodes may be identified and collected. Based on the transactions, edges connecting the nodes may be added. The direction of the edges may be based on the direction of the transaction.

In Step 520, weight of edges between nodes may be determined based on the transactions associated with respective edge.

In Step 525, a predictive model may be determined for each node of the graph based on the business transactions. In some exemplary embodiments, the model may be determined based on observed input and output vectors associated with the node at each monitored cycle.

In Step 530, the user may provide a query to the economic simulator, such as via a GUI. In some exemplary embodiments, based on the query a simulation scenario may be generated and the simulator may be updated accordingly to follow the simulation scenario. In some exemplary embodiments, based on the query, initial values of the simulator may be determined and updated (535) and predictions as to results of the effects of the updated values may be simulated for a predetermined number of cycles (540)

In Step 550, predicted results may be outputted to the user using a report. In some exemplary embodiments, the user may view the results using a GUI which may provide for a visualization of the predictions.

Referring now to FIG. 6 showing a block diagram of an apparatus, in accordance with some exemplary embodiments of the disclosed subject matter.

Apparatus 600 may be a computerized apparatus adapted to perform the method depicted in FIG. 5 or implement the disclosed subject matter in a different manner.

In some exemplary embodiments, Apparatus 600 may comprise a Processor 602. Processor 602 may be a Central Processing Unit (CPU), a microprocessor, an electronic circuit, an Integrated Circuit (IC) or the like. Alternatively, Apparatus 600 can be implemented as firmware written for or ported to a specific processor such as Digital Signal Processor (DSP) or microcontrollers, or can be implemented as hardware or configurable hardware such as field programmable gate array (FPGA) or application specific integrated circuit (ASIC). The Processor 602 may be utilized to perform computations required by Apparatus 600 or any of it subcomponents.

In some exemplary embodiments of the disclosed subject matter, Apparatus 600 may comprise an Input/Output (I/O) Module 605 such as a terminal, a display, a keyboard, an input device or the like to interact with the system, to invoke the system and to receive results. It will however be appreciated that the system can operate without human operation. In some exemplary embodiments, the I/O Module 605 may be utilized to provide an interface to a user to interact with Apparatus 600, such as by viewing the network graph, testing the modeling of each node, providing queries, viewing outputs of the simulator, or the like.

In some exemplary embodiments, Apparatus 600 may comprise a Memory Unit 607. Memory Unit 607 may be persistent or volatile. For example, Memory Unit 607 can be a Flash disk, a Random Access Memory (RAM), a memory chip, an optical storage device such as a CD, a DVD, or a laser disk; a magnetic storage device such as a tape, a hard disk, storage area network (SAN), a network attached storage (NAS), or others; a semiconductor storage device such as Flash device, memory stick, or the like. In some exemplary embodiments, Memory Unit 607 may retain program code operative to cause Processor 602 to perform acts associated with any of the steps shown in FIG. 5 above.

The flowchart and block diagrams in the figures illustrate the architecture, functionality, and operation of possible implementations of systems, methods and computer program products according to various embodiments of the present disclosure. In this regard, each block in the flowchart and some of the blocks in the block diagrams may represent a module, segment, or portion of program code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, any non-transitory computer-readable medium, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A computer-implemented method comprising:
obtaining business transactions from a business collaboration network, wherein each business transaction is a business-to-business transaction; and
automatically generating, by a processor, based on the business transactions, an economic simulator capable of simulating economic activity within the business collaboration network, wherein the economic activity is associated with a business transaction that is transmitted via the business collaboration network.

2. The computer-implemented method of claim 1, wherein said automatically generating comprises:
building a graph of business relations between business entities based on the business transactions, wherein the graph comprises nodes and edges connecting between nodes, wherein each node is associated with a business entity, wherein an edge between two nodes indicates business transaction between corresponding business entities; and
determining a predictive model for each node of the graph, wherein the predictive model is based on the incoming and outgoing business transactions associated with the node.

3. The computer-implemented method of claim 2, wherein at least one node is associated with a plurality of business entities, wherein the plurality of business entities have a common characterization.

4. The computer-implemented method of claim 3, wherein the plurality of business entities represent an industry, wherein an indication of an industry of a business entity is not obtained from the business transactions.

5. The computer-implemented method of claim 2, wherein the edges are weighted edges indicating a strength measurement of the relationship.

6. The computer-implemented method of claim 1 further comprises simulating an economic event on a business environment modeled by the economic simulator and providing predictions as to the effect of the economic event on the business environment.

7. The computer-implemented method of claim 1 further comprising:
receiving a query from a user as to an effect of the economic event;
simulating the economic event using the economic simulator; and
reporting predictions to the user.

8. The computer-implemented method of claim 7, wherein the economic event is selected from a group consisting of: a change in demand and a price change of a factor of production.

9. The computer-implemented method of claim 7, wherein the economic event is localized to a geographic location or an industry.

10. The computer-implemented method of claim 1, wherein the business collaboration network is a Value Added Network (VAN) that enables encrypted transmission of business transactions between different business entities.

11. A computerized apparatus having a processor coupled with a memory unit, the processor being adapted to perform the steps of:
obtaining business transactions from a business collaboration network, wherein each business transaction is a business-to-business transaction; and
automatically generating, by a processor, based on the business transactions, an economic simulator capable of simulating economic activity within the business collaboration network, wherein the economic activity is associated with a business transaction that is transmitted via the business collaboration network.

12. The computerized apparatus of claim 11, wherein said automatically generating comprises:
building a graph of business relations between business entities based on the business transactions, wherein the graph comprises nodes and edges connecting between nodes, wherein each node is associated with a business entity, wherein an edge between two nodes indicates business transaction between corresponding business entities; and
determining a predictive model for each node of the graph, wherein the predictive model is based on the incoming and outgoing business transactions associated with the node.

13. The computerized apparatus of claim 12, wherein at least one node is associated with a plurality of business entities, wherein the plurality of business entities have a common characterization.

14. The computerized apparatus of claim 13, wherein the plurality of business entities represent an industry, wherein an indication of an industry of a business entity is not obtained from the business transactions.

15. The computerized apparatus of claim 12, wherein the edges are weighted edges indicating a strength measurement of the relationship.

16. The computerized apparatus of claim 11, wherein the processor is further adapted to simulate an economic event on a business environment modeled by the economic simulator and providing predictions as to the effect of the economic event on the business environment.

17. The computerized apparatus of claim 11, wherein the processor is further adapted to:
receive a query from a user as to an effect of the economic event;
simulate the economic event using the economic simulator; and
report predictions to the user.

18. The computerized apparatus of claim 17, wherein the economic event is selected from a group consisting of: a change in demand and a price change of a factor of production.

19. The computerized apparatus of claim 17, wherein the economic event is localized to a geographic location or an industry.

20. The computerized apparatus of claim 11, wherein the business collaboration network is a Value Added Network (VAN) that enables encrypted transmission of business transactions between different business entities.

21. A computer program product comprising a non-transitory computer readable medium retaining program instructions, which instructions when read by a processor, cause the processor to perform the steps of:
obtaining business transactions from a business collaboration network, wherein each business transaction is a business-to-business transaction; and
automatically generating, by a processor, based on the business transactions, an economic simulator capable of simulating economic activity within the business collaboration network, wherein the economic activity is associated with a business transaction that is transmitted via the business collaboration network.

22. The computer program product of claim 21, wherein said automatically generating comprises:
building a graph of business relations between business entities based on the business transactions, wherein the graph comprises nodes and edges connecting between nodes, wherein each node is associated with a business entity, wherein an edge between two nodes indicates business transaction between corresponding business entities; and
determining a predictive model for each node of the graph, wherein the predictive model is based on the incoming and outgoing business transactions associated with the node.

23. The computer program product of claim 21, wherein the instructions further cause to processor to:
receive a query from a user as to an effect of the economic event;
simulate the economic event using the economic simulator; and
report predictions to the user.
